(19) United States
(12) Patent Application Publication
(10) Pub. No.: US 2012/0040194 A1
(43) Pub. Date: Feb. 16, 2012

(54) SURFACE-TREATED PRECOATED METAL SHEET, PROCESS FOR PRODUCING SAME, AND SURFACE-TREATING SOLUTION

(75) Inventors: Takao Kanai, Tokyo (JP); Hiromasa Nomura, Tokyo (JP); Tomonari Hamamura, Tokyo (JP); Hiroshi Kanai, Tokyo (JP); Hiroyuki Oyokawa, Tokyo (JP)

(73) Assignee: NIPPON STEEL CORPORATION, Tokyo (JP)

(21) Appl. No.: 13/201,868

(22) PCT Filed: Feb. 17, 2010
(86) PCT No.: PCT/JP2010/052799

§ 371 Date: Oct. 28, 2011

(30) Foreign Application Priority Data
Feb. 18, 2009 (JP) 2009-035901

(51) Int. Cl. B32B 15/08; B05D 3/02; B01J 31/06

(52) U.S. Cl. 428/447; 502/159; 427/386; 427/387

(57) ABSTRACT

Disclosed is a surface-treated precoated metal sheet of which resistance against contamination with a photocatalyst and a self-cleaning function can be retained for a long period. Also disclosed are a method and a surface-treating solution for producing the surface-treated precoated metal sheet properly. The surface-treated precoated metal sheet is characterized by comprising a precoated metal sheet comprising an under metal sheet and an organic resin coating layer provided on the surface of the under metal sheet and a coating film having at least two layers, having a photocatalytic activity and formed on the precoated metal sheet, wherein the coating film having at least two layers comprises an inorganic-organic composite resin composed of a condensed product of an alkoxysilane selected from a group consisting of an alkoxysilane having an organic group selected from a group consisting of an alkyl group having 1 to 12 carbon atoms, an aryl group, a carboxyl group, a hydroxy group and a combination of two or more of these groups, an alkoxysilane having an epoxy group, an alkoxysilane having an amino group, a tetraalkoxysilane and a combination of two or more of the alkoxysilanes and contains a substance having a photocatalytic activity in such an amount that the content of the substance is highest in the outermost layer of the coating film and is gradually decreased toward an inner layer of the coating film.

### TECHNICAL FIELD

The present invention relates to a surface-treated precoated metal sheet which includes, on a surface of a precoated metal sheet including an organic resin coating layer, at least a two-layered film which exhibits a photocatalytic activity, and is excellent in fouling resistance; a method for producing the same; and a surface-treating solution for suitably producing the surface-treated precoated metal sheet. More specifically, the present invention relates to a surface-treated precoated metal sheet which includes, on a surface, at least a two- or multi-layered film made of a substance having a photocatalytic activity and an inorganic-organic composite resin which is reduced in deterioration due to a photocatalyst, thereby having photocatalytic activity over a long period, and is also excellent in weatherability; and a method for producing the same. The present invention also relates to a surface-treating solution for suitably producing the surface-treated precoated metal sheet.

### BACKGROUND ART

A metallic material typified by iron is commonly used after painting for the purpose of improving durability or obtaining beautiful appearance. The painted metallic material is widely used in household electric appliances, automobiles, building materials and outdoor structures. In particular, with respect to outdoor uses, since the metallic material is exposed to rain, wind, dust and the like, the metallic material must be excellent in fouling resistance in addition to corrosion resistance.

Photocatalyst technology is the technology of hydrophilizing a surface by utilizing a photocatalytic activity of photocatalyst particles, and decomposing and removing fouling materials, mainly organic substances. In a surface-treated metal, fouling resistance and self-cleaning are expected by allowing particles having excellent photocatalytic activity to disperse or be contained in a surface film. This technology can exert an excellent effect on decomposition and removal of the fouling materials on the surface. However, when photocatalyst particles are dispersed in an organic resin-based paint film or a photocatalyst film is formed on a surface of the organic resin-based paint film, a photocatalytic effect causes gradual decomposition of the organic resin-based paint film, resulting in deterioration. Therefore, it was difficult to use the surface-treated metal over a long period.

To cope with this problem, a technology for suppressing deterioration of a paint film was proposed. For example, Patent Document 1 and Patent Document 2 disclose methods in which an inorganic component is used as a resin constituting a film. Among organic resins, since a fluororesin is comparatively stable against a photocatalyst, there is disclosed a method in which the fluororesin is used as a film component (Patent Document 3). In particular, a resin for precoated metal requires high stability against the photocatalyst and processability. For this purpose, Patent Document 4 and Patent Document 5 respectively disclose a method in which a silica-organosilane-based resin is used as a film component and a method in which an alkyl silicate obtained by a polymerization reaction between an acrylic resin and an organoalkoxysilane is used as a film component. Also, Patent Document 6 discloses a method in which a vinylidene fluoride resin and an acrylic resin are used.

The inventors have also proposed film resin components which satisfy high stability, i.e. excellent weatherability and processability against a photocatalyst, which can also be used for a precoated metal, at a high level (Patent Documents 7 to 9).

### PRIOR ART DOCUMENTS

### Patent Documents

Patent Document 1: JP 07-113272 A
Patent Document 2: JP 08-164334 A
Patent Document 3: JP 07-171408 A
Patent Document 4: JP 10-225658 A
Patent Document 5: JP 2000-317393 A
Patent Document 6: JP 2000-063733 A
Patent Document 7: JP 2006-192716 A
Patent Document 8: JP 2006-192717 A
Patent Document 9: JP 2007-268761 A

### DISCLOSURE OF THE INVENTION

### Problems to be Solved by the Invention

According to the study of the inventors, even when the aforementioned resin having excellent weatherability is used, photocatalyst and sunlight causes deterioration of a film and chalking arises, and thus a photocatalyst film gradually depletes. It has been found that as a result, a photocatalytic action is lost when a photocatalyst film on the surface disappears, and thus fouling resistance and self-cleaning performance drastically deteriorate.

Heretofore, a post-coating method has been employed mainly as a method of forming a photocatalyst film. Therefore, a photocatalyst film was commonly formed after forming a metallic material into a shape of a final product. In the case of building materials and outdoor structures, a photocatalyst film was commonly formed during construction. According to this method, since the film is formed by painting after forming into the shape of the final product or painting, there is no limitation on a film-forming resin and a coated film thickness, and a film in accordance with a required performance could be formed.

However, in a precoated metal which is painted in advance and shipped it is difficult to form a film having a given thickness or more from the viewpoint of restriction of processability and costs, and it was desired to develop a precoated metal sheet which can maintain fouling resistance, self-cleaning properties over a long period in this restriction.

The present invention has been made so as to solve this problem and an object thereof is to provide a surface-treated precoated metal sheet which can maintain fouling resistance due to a photocatalyst and a self-cleaning function over a long period in conditions where restriction of a film thickness or the like exists. Another object of the present invention is to provide a method and a surface-treating solution for suitably producing the aforementioned surface-treated precoated metal sheet.

### Means for Solving the Problems

The inventors have achieved the aforementioned objects and found that the aforementioned problems can be solved by a surface-treated precoated metal sheet including an at least two-layered film (photocatalyst film) made of an inorganic-organic composite resin containing a substance having a photocatalytic activity mixed therein and formed on a surface of a precoated metal sheet including an organic resin coating layer, and thus the present invention has been completed. Describing in detail, it is a surface-treated precoated metal sheet wherein a function, as a protective layer, of protecting an organic resin is maintained by adding a photocatalyst also to a protective layer which has conventionally been provided between a photocatalyst film and an organic resin paint film so as to protect the organic resin paint film as a lower layer of the photocatalyst film, and fouling resistance and a self-cleaning function due to the photocatalyst added to the protective layer are also exerted even after the photocatalyst film layer on the surface underwent depletion and disappeared. Specifically, the present invention is as follows.

(1) A surface-treated precoated metal sheet having at least two-layered film having a photocatalytic activity formed on a precoated metal sheet, the precoated metal sheet having a substrate metal sheet and an organic resin coating layer on a surface thereof, wherein the at least two-layered film contains an inorganic-organic composite resin composed of a condensate of an alkoxysilane, which is selected from the group consisting of alkoxysilanes having an organic group selected from the group consisting of alkyl groups having 1 to 12 carbon atoms, aryl groups, carboxyl group, hydroxyl group and combinations thereof, alkoxysilanes having an epoxy group, alkoxysilanes having an amino group, tetraalkoxysilanes and combinations thereof, and also contains a substance having a photocatalytic activity so that the content thereof is the largest in an outermost layer and gradually decreases toward an inner layer.
(2) The surface-treated precoated metal sheet as set forth in (1), wherein the organic group contained in the inorganic-organic composite resin is a methyl group or a phenyl group.
(3) The surface-treated precoated metal sheet as set forth in (1) or (2), wherein the content of substance having a photocatalytic activity in each layer of the film is from 0.05% to 50% of the total mass of the layer.
(4) The surface-treated precoated metal sheet as set forth in any one of (1) to (3), wherein the content of a photocatalyst substance in an innermost layer in contact with the organic resin coating layer is from 0.05 to 30% by mass based on the total mass of the innermost layer.
(5) The surface-treated precoated metal sheet as set forth in any one of (1) to (4), wherein the substance having a photocatalytic activity is titanium oxide including an anatase type structure.
(6) The surface-treated precoated metal sheet as set forth in any one of (1) to (5), wherein the substrate metal sheet is selected from steel sheets, stainless steel sheets, titanium sheets, titanium alloy sheets, aluminum sheets, aluminum alloy sheets, or plated metal sheets obtained by subjecting said metal sheets to a plating treatment.
(7) A surface-treating solution comprising an inorganic-organic composite resin material containing an alkoxysilane (a1), which is selected from the group consisting of alkoxysilanes having an organic group selected from the group consisting of alkyl groups having 1 to 12 carbon atoms, aryl groups, carboxyl group, hydroxyl group and combinations thereof, alkoxysilanes having an epoxy group, alkoxysilanes having an amino group, tetraalkoxysilanes and combinations thereof, a hydrolyzate (a2) of the alkoxysilane (a1) and/or a condensate (a3) of the alkoxysilane (a1); and a substance having a photocatalytic activity.
(8) A method for producing a surface-treated precoated metal sheet, which comprises applying the surface-treating solution as set forth in (7) to a precoated metal sheet including an organic resin coating layer, and curing the surface-treating solution.
(9) A method for producing a surface-treated precoated metal sheet, which comprises simultaneously applying a plurality of the surface-treating solutions as set forth in (7), the contents of the substance having a photocatalytic activity being different from solution to solution, on a precoated metal sheet having an organic resin coating layer; and then simultaneously drying and baking the surface-treating solutions to form, on the organic resin coating layer, a multi-layered film so that the content of the substance having a photocatalytic activity is the largest in an outermost layer and gradually decreases toward an inner layer.

### Effects of the Invention

According to the present invention, it is possible to easily obtain a surface-treated precoated metal sheet which can maintain and continue fouling resistance imparted by a photocatalyst and a self-cleaning function over a long period. It is also possible to suitably produce the aforementioned surface-treated precoated metal sheet by using a production method and a surface-treating solution of the present invention.

### MODE FOR CARRYING OUT THE INVENTION

The precoated metal sheet having excellent fouling resistance of the present invention is a precoated metal sheet in which, on a painted surface of a common precoated metal sheet as a product in the form of being painted on a surface of a metal sheet, a further paint film layer exhibiting fouling resistance is formed. Exhibition of fouling resistance imparted by the further paint film layer is caused by the fact that the layer contains a substance having a photocatalytic activity (photocatalyst substance) which exerts an excellent effect on decomposition and removal of fouling materials on the surface.

There has hitherto been known a precoated metal sheet with a layer configuration, in which a paint film layer contributing to fouling resistance by inclusion of a photocatalyst substance is further provided on a coated surface of a precoated metal sheet. In such a conventional precoated metal sheet, since the film layer containing a photocatalyst substance is contacted with a paint film layer of a precoated metal sheet formed commonly of an organic resin-based material and the paint film layer of the precoated metal sheet as a substrate is gradually decomposed by a photocatalytic effect of the photocatalyst substance, resulting in proceeding of deterioration of the paint film layer. Therefore, it is difficult to use the precoated metal sheet over a long period. In particular, in order to exert an excellent effect on fouling such as sealing fouling which is not easily decomposed even by the photocatalyst, a large amount of photocatalyst must be added. Therefore, the paint film layer on the surface of the precoated metal sheet undergoes severe deterioration and photocatalyst layer per se severely depletes.

To avoid this drawback, a protective layer containing no photocatalyst substance has hitherto been inserted between a film layer containing a photocatalyst substance and an organic resin-based paint film layer as a lower layer. It is common that the photocatalyst layer and the protective layer are mainly made of an inorganic component so as to ensure photocatalyst resistance. However, it is difficult for a film made mainly of an inorganic component to have a thickness over a certain value since it has unsatisfactory processability. Therefore, this method had such a drawback that the thickness of the photocatalyst layer must be decreased by the thickness of the protective layer film to be formed, and thus fouling resistance and self-cleaning properties deteriorate.

The present invention has succeeded in significantly maintaining fouling resistance of a precoated metal sheet when compared with the case (1) where a layer containing a photocatalyst substance (photocatalyst layer) is provided directly on an organic resin-based paint film layer, and the case (2) where a protective layer containing no photocatalyst substance and a layer containing a photocatalyst substance are sequentially provided on an organic resin-based paint film layer, as in the case of prior art, by adding, to a protective layer which has been used for the purpose of avoiding direct contact between a film layer containing a photocatalyst substance and an organic resin-based paint film layer as a lower layer, a photocatalyst in the amount less than the content of the photocatalyst substance of a layer thereabove (for example, a persistence time of the fouling resistance effect of Example 8 and that of Comparative Example 1 are respectively about 9 years and about 2 years (see “Persistence period of self-cleaning properties” of Table 1)).

As described above, the present invention has been made on the basis of a novel and unique finding that a persistence time of a fouling resistance effect can, if anything, be prolonged by adding a photocatalyst substance to a protective layer, which has hitherto been existing between a film layer containing a photocatalyst substance and an underlying organic resin-based paint film layer, without having a photocatalyst substance added, so as to avoid direct contact between the film layer and the organic resin-based paint film layer for the purpose of avoiding a photocatalytic effect of the film layer from exerting on the underlying layer.

The entire paint film thickness of the precoated metal sheet, which is shipped in a coated state and is formed without the need of coating in consumers, is restricted from the viewpoint of processability. According to the present invention which can prolong a persistence time of a fouling resistance effect when compared with prior art, it is possible to provide a precoated metal sheet which is more excellent in fouling resistance effect within the restriction of the paint film thickness.

The reason why the fouling resistance effect is prolonged by the present invention is considered as follows.

There have hitherto been known, as typical paint film configurations of a precoated metal sheet which exert a fouling resistance function imparted by a photocatalytic effect, as described above, a configuration (1) in which a photocatalyst layer is provided directly on an organic resin-based paint film layer of a precoated metal sheet, and a configuration (2) in which a protective layer is provided between an organic resin-based paint film layer of a precoated metal sheet and a photocatalyst layer. In these cases, a study is made on a period A until a photocatalyst layer disappears by depletion as a result of deterioration of the photocatalyst layer due to its own photocatalytic action, and a period B until a surface of an organic resin paint film of a precoated metal sheet in contact with a photocatalyst layer deteriorates due to a photocatalytic effect. In (1), since a photocatalyst layer is contacted directly with an organic resin paint film layer of a base material (which herein means a precoated metal sheet composed of a substrate metal sheet and an organic resin paint film layer formed on the surface thereof), a period B1 until a surface of an organic resin paint film deteriorates due to a photocatalytic effect is in general shorter than a period Al until a deteriorated photocatalyst layer disappears due to depletion, and a relationship: Al>B1 is established. In (2), since an organic resin-based paint film layer is protected by a protective layer, a period B2 until a surface of an organic resin paint film deteriorates due to a photocatalytic effect is drastically longer than a period A2 until a deteriorated photocatalyst layer disappears due to depletion, and a relationship: A2<<B2 is established. Therefore, a persistence period of fouling resistance imparted by a photocatalyst and a self-cleaning function is dominated by B1 in case of (1), or dominated by A2 in case of (2).

On the other hand, in the present invention, since a photocatalyst is also added to a conventional protective layer film, A3 can be made nearly identical to B3 by adjusting the amount of photocatalyst added and the film thickness (wherein A3 is a period until a deteriorated photocatalyst layer disappears due to depletion, and B3 is a period until a surface of an organic resin paint film deteriorates due to a photocatalytic effect). In other words, when compared for the identical film thicknesses, according to the present invention, fouling resistance imparted by a photocatalytic effect and self-cleaning effect are maintained over the longest period when compared with the aforementioned (1) and (2), and thus an excellent effect can be exerted on a precoated metal sheet which undergoes restriction of the paint film thickness.

Herein, in the aforementioned conventional case (1), by forming a so-called paint film layer with the gradient composition in which the concentration of a photocatalyst in the vicinity of a surface of a photocatalyst layer is controlled to high and the concentration of the photocatalyst in the vicinity of an organic resin-based paint film layer is controlled to low, the same effect as the aforementioned effect of the present invention may be obtained. However, it is very difficult to control the concentration of the photocatalyst in a thickness direction in a single paint film. In the present invention, since the additive amounts of the photocatalyst can vary for respective layers of a two- or multi-layered film, it is possible to easily set a persistence time of an anti-fouling and self-cleaning function.

Furthermore, the following effect can be anticipated by also adding a photocatalyst to a protective layer. An outermost photocatalyst layer gradually depletes due to the effect of the photocatalyst. However, the outermost photocatalyst layer does not necessary deplete uniformly and, in case of seeing microscopically, a region where a film largely remains (less depletion of the film) and a region where a film slightly remains (much depletion of the film) exist and depletion arises while forming unevenness in a thickness direction. In the case where the photocatalyst film depletes and interface with a protective layer is exposed, since the protective layer has no self-cleaning effect, self-cleaning properties drastically deteriorate when a certain proportion of the protective layer is exposed. On the contrary, since a self-cleaning function can also be imparted to the protective layer by adding a photocatalyst, excellent self-cleaning properties can be maintained even after the protective layer is exposed. In other words, in the case where the photocatalyst is not added to the protective layer, self-cleaning properties deteriorate even when an outermost photocatalyst layer remains. In contrast, in the surface-treated precoated metal sheet of the present invention in which the photocatalyst is also added to the protective layer, sufficient self-cleaning properties are obtained while the photocatalyst film remains. Taken together, it is considered that fouling resistance and self-cleaning properties can be exhibited over the entire period during which the photocatalyst film formed on the precoated metal sheet exists by adding the photocatalyst to the protective layer, and also the aforementioned effect can be maintained even after a certain proportion of the protective layer was exposed, and thus self-cleaning life can be prolonged. As a result, it is considered that the persistence time of fouling resistance effect shown in Comparative Example 1 was about 2 years, whereas remarkably long life of about 9 years was achieved in Example 8, for example.

The surface-treated precoated metal sheet of the present invention has a characteristic in a surface film, and has the component and structure, which are less likely to cause deterioration, even when a substance having a photocatalytic activity (hereinafter also referred to as a “photocatalyst”) is contained. Specifically, the surface film has a multi-layered structure in which the content of the photocatalyst is the largest in an outermost layer film and gradually decreases toward an inner layer film, and also contains an inorganic-organic composite resin composed of a condensate of an alkoxysilane, which is selected from the group consisting of alkoxysilanes having an organic group selected from the group consisting of alkyl groups having 1 to 12 carbon atoms, aryl groups, carboxyl group, hydroxyl group and combinations thereof, alkoxysilanes having an epoxy group, alkoxysilanes having an amino group, tetraalkoxysilanes and combinations thereof. Herein, the condensate of alkoxysilane is produced by hydrolyzing the alkoxysilane used as a raw material to form a hydrolyzate, and then subjective the hydrolyzate to drying and baking (heat treatment). As described above, since the material constituting a matrix of the surface film is prepared by mixing an organic substance with an inorganic resin containing silicon as a main component, the surface film is excellent in processability, in addition to excellent stability against the photocatalyst, and weatherability.

Herein, examples of the alkyl groups having 1 to 12 carbon atoms include a methyl group, an ethyl group, a propyl group, a butyl group, a hexyl group, a 2-ethylhexyl group, a dodecyl group and the like. Examples of the aryl groups include a phenyl group, a tolyl group, a xylyl group, a naphthyl group and the like. The carboxyl group means —COOH, the amino group means —NH₂, and the hydroxyl group means —OH, respectively. Among these groups, a methyl group or a phenyl group is used as the organic group in the present invention, particularly suitably. It is also possible to simultaneously use two or more kinds of organic components used in the present invention.

The surface-treated precoated metal sheet of the present invention has, on its surface, at least two-layered film containing a photocatalyst (hereinafter also referred to as a “surface-treated film” or a “photocatalyst film”). This is intended to maintain fouling resistance imparted by the photocatalyst, or self-cleaning effect over a long period. In a conventional photocatalyst film, self-cleaning properties deteriorate drastically and quickly at a stage where a photocatalyst film deteriorates, or an organic resin coating layer having no photocatalytic action of a substrate is exposed by chalking. In contrast, the surface-treated precoated metal sheet of the present invention can maintain self-cleaning properties imparted by the photocatalyst over a long period since at least a two-layered photocatalyst film is formed.

In the at least two-layered photocatalyst film, the content of the photocatalyst gradually decreases toward an inner layer film close to a substrate metal sheet. Therefore, even after a photocatalyst film at the outer layer, which has a large photocatalyst content, is lost, sufficient self-cleaning properties can be obtained over a long period, although a remarkable effect is not maintained when compared with an initial state. As described above, the photocatalyst film having a multi-layered structure of the present invention can also suppress deterioration of the photocatalyst film layer and can realize a surface-treated precoated metal sheet which is free of fouling over a long period.

Typical examples of the substance having a photocatalytic activity used in the photocatalyst film of the present invention include photocatalyst particles. In the surface-treated precoated metal sheet of the present invention, not only particles, but also a sol-like substance or a substance obtained by coagulation of heated metal complex may be used.

The content of the photocatalyst in the photocatalyst film is the largest in an outermost layer film and gradually decreases toward an inner layer film. Titanium oxide containing an anatase type structure is popular as the photocatalyst and is most suitably used as the photocatalyst of the present invention. However, the photocatalyst of the present invention is not limited to the anatase type titanium oxide and other photocatalysts, for example, TiO₃ SrTiO₃, FeTiO₃, WO₃, SnO₂, Bi₂O₃, In₂O₃, ZnO, Fe₂O₃, RuO₂, CdO, CdFeO₃, LaRhO₃, Nb₂O₅, ZeO₂, Ta₂O₅ and the like are suitably used and can be appropriately selected depending on desired performance and the like.

In many cases, although photocatalyst particles are commonly used as the photocatalyst, there is no particular limitation on the properties of photocatalyst particles used in the present invention. However, are particles preferred, which are as fine as possible, so as to obtain a high catalytic activity. The size of photocatalyst particles is preferably 0.5 μm or less, more preferably 0.1 μm or less, and even more preferably 0.05 μm or less, in terms of a primary particle diameter. There is no particular limitation on the lower limit of particle size. However, since it becomes difficult to handle when the particle size is too small, usually, particles having a primary particle diameter of 5 nm or more are suitably used.

When particles having a small particle diameter and a high activity are used as the catalyst, an excellent photocatalytic effect, i.e., an effect of removal of fouling substances can be obtained. However, usually, a film matrix portion retaining the photocatalyst simultaneously deteriorates, and thus it is impossible for the matrix portion to endure use over a long period. Since the film matrix portion used in the present invention remarkably suppress deterioration due to photocatalyst particles by being formed of an inorganic-organic composite resin, photocatalyst particles having a small particle diameter and a high activity can be used without any particular obstacle. Also, when fine photocatalyst particles are used, since they are difficult to be dispersed, agglomerates may be formed in the film. However, a resin component constituting the film may be often absent in the gap between the agglomerates, and thus there may be an advantage that the fouling substances easily reach a catalyst surface.

It is desired that the photocatalyst is uniformly dispersed in the film. However, it is not necessarily required to pursue complete uniformity and homogeneity. For example, as described above, there can be exemplified a case where agglomerates are formed, a case where the concentration of particles varies with the outermost surface portion and the interior portion, or the concentration gradient is imparted, etc., and these photocatalyst films can also be suitably used.

There is no particular limitation on the amount of the photocatalyst in each layer of the film, and the amount can be appropriately determined as long as the desired effect is obtained. In this case, the amount is usually adjusted to 50% or less, preferably 40% or less, and more preferably 30% or less, of the total mass of each layer so that uniformity, smoothness and the like of the film are not impaired. There is also no particular limitation on the lower limit of the additive amount, and the additive amount is usually 0.05% or more, preferably 0.1% or more, more preferably 0.5% or more, and most preferably 1.0% or more, of the total mass of each layer. When the additive amount is too large exceeding the aforementioned range, it becomes difficult to from a uniform and smooth film, as described above, and also it is not economical. In contrast, when the additive amount is too small outside the aforementioned range, no desired effect may often be obtained.

The amount of the photocatalyst contained in the at least two-layered photocatalyst film used in the present invention is the largest in an outermost layer film and decreases toward an innermost layer. As a result, even when the outermost layer film causes deterioration and chalking and thus disappears, leading to a film of the second layer being exposed, the effect of maintaining an anti-fouling effect can be expected and excellent fouling resistance and self-cleaning effect can be obtained over a long period, although self-cleaning properties are slightly inferior to those obtained by the outermost layer. Since the content of the photocatalyst decreases toward the inner layer film, deterioration of the film is suppressed and thus excellent self-cleaning properties are maintained over a long period.

There is no particular limitation on the amounts of the photocatalyst in respective layers of the film in which the content of the photocatalyst is varied, and the amounts of the photocatalyst can be appropriately determined within the aforementioned amount of the photocatalyst. For example, when a two-layered film is formed, a combination of the amount of the photocatalyst in the outermost layer film and that in the two-layered film can be set to 50%/20%, 35%/10% or 20%/5% (in order of outermost layer film/second layer film) based on the total masses of respective layers. In a case of three-layered film, it is possible to set to 50%/30%/10%, 35%/20%/10% or 20%/15%/1% (in order of outside layer/middle layer/inside layer) based on the total masses of respective layers.

The amount of the photocatalyst of the inner layer film is as described above and, desirably, the content of the photocatalyst in the innermost film may be adjusted within a range from 0.05 to 30% by mass based on the entire innermost layer film. Since the innermost layer film is in contact with a film (organic resin paint film) containing, as a main component, an organic resin such as polyester, urethane, acrylic or epoxy formed on a surface of a precoated metal sheet as a base material, it is desired that the innermost layer film does not contain the photocatalyst in the amount more than the necessary amount. The amount of the photocatalyst in the innermost film is preferably from 0.05 to 20% by mass, and more preferably from 0.1 to 15% by mass, based on the total mass of innermost layer film.

The substance having a photocatalytic activity can exist in the film in a state of being as it is, and also can be used in a state of being supported on a carrier surface. Since use of the carrier enables a drastic decrease in an area where the photocatalyst and a matrix constituting the film are in contact directly with each other, deterioration of the matrix portion due to the photocatalyst can be suppressed. Also in a case of the combination of a coating material (resin) and photocatalyst particles, which may cause difficulty in dispersion, it is possible to obtain a film, which is more excellent in a dispersion state of the photocatalyst, by selecting a material suited for use as the carrier. There may be suitably used, as the carrier, an inorganic oxide which is stable against the photocatalyst, particularly silicon oxide, aluminum oxide, magnesium oxide, zirconium oxide, iron oxide, calcium oxide or the like.

The thicknesses of the photocatalyst films used in the present invention can be respectively determined independently in a two- or multi-layered film and vary depending on the required characteristics or applications, and a single layer of film has preferably a thickness of 0.05 μm to 25 μm, and more preferably 0.1 μm to 20 μm. When the film thickness is restricted more severely, the film thickness is preferably adjusted to 0.1 μm to 10 μm. When the film thickness is small outside the range, it is difficult that a uniform film is formed thereby providing predetermined characteristics. In contrast, when the film thickness is too large exceeding the aforementioned range, formability may not be sufficient or adhesion during processing may become insufficient.

In the catalyst film of the present invention, Si is contained as a metal component and it is possible to add to the film, as the element other than Si, one or more kinds of metallic element selected from B, Al, Ge, Ti, Y, Zr, Nb, Ta and the like. Among these metal elements, Al, Ti, Nb and Ta exert a function of completing solidification of a film by an acid catalyst at a low temperature or within a short time when added as a metal alkoxide in the system. When the metal alkoxide is added together with the acid catalyst, a ring-opening rate of epoxy increases and thus it becomes possible to cure the film at a low temperature within a short time. Ti is used particularly often and an alkoxide of Ti, such as Ti-ethoxide, Ti-isopropoxide or the like is used. In the system containing Zr added therein (for example, a system in which Zr is added in the form of a zirconium alkoxide), since alkali resistance of the film is remarkably improved, it is suitably used in applications which require alkali resistance.

It is possible to suitably use, as the substrate metal sheet of the precoated metal sheet, which serves as a base material of the surface-treated precoated metal sheet of the present invention, any substrate metal sheet regardless of the material thereof. For example, it is possible to suitably use a sheet material or a plated sheet material made of carbon steel, stainless steel, titanium, aluminum, aluminum alloy or the like. Examples of particularly preferred substrate metal sheets include carbon steel sheets, stainless steel sheets, titanium sheets, aluminum sheets, aluminum alloy sheets and plated metal sheets obtained by subjecting these sheets to a plating treatment. Examples of the plated steel sheets include zinc-plated steel sheets, zinc-iron alloy-plated steel sheets, zinc-nickel alloy-plated steel sheets, zinc-chrome alloy-plated steel sheets, zinc-aluminum alloy-plated steel sheets, aluminum-plated steel sheets, zinc-aluminum-magnesium alloy-plated steel sheets, zinc-aluminum-magnesium-silicone alloy-plated steel sheets, aluminum-silicone alloy-plated steel sheets, zinc-plated stainless steel sheets, aluminum-plated stainless steel sheets and the like. Examples of the stainless steel sheets include ferrite stainless steel sheet, martensite stainless steel sheets, an austenite stainless steel sheets and the like. The stainless steel sheets include sheets having a thickness of about several tens of mm, and stainless steel foils having a thickness reduced to about 10 μm by rolling. The surfaces of the stainless steel sheet and stainless steel foil may be subjected to a surface treatment such as bright annealing, buffing or the like. Examples of the aluminum alloy sheets include JIS 1000 series (pure Al-based alloy), JIS 2000 series (Al—Cu-based alloy), JIS 3000 series (Al—Mn-based alloy), JIS 4000 series (Al—Si-based alloy), JIS 5000 series (Al—Mg-based alloy), JIS 6000 series (Al—Mg—Si-based alloy), JIS 7000 series (Al—Zn-based alloy) and the like.

The precoated metal sheet of the present invention may be any of those in which an organic resin coating layer is formed directly on the aforementioned substrate metal surface, or those in which an organic resin coating layer is formed through a middle layer. Examples of the middle layers include chromate films, phosphate films formed by a phosphate treatment, and the like. The organic resin coating layer is typically a polyester resin paint film crosslinked with melamine or isocyanate, a fluororesin paint film, an acrylic resin paint film or the like.

The treating solution for suitable production of the surface-treated precoated metal sheet of the present invention is a solution containing an inorganic-organic composite resin material containing an alkoxysilane (a1), which is selected from the group consisting of alkoxysilanes having an organic group selected from the group consisting of alkyl groups having 1 to 12 carbon atoms, aryl groups, carboxyl group, hydroxyl group and combinations thereof, alkoxysilanes having an epoxy group, alkoxysilanes having an amino group, tetraalkoxysilanes and combinations thereof, a hydrolyzate (a2) of the alkoxysilane (a1) and/or a condensate (a3) of the alkoxysilane (a1); and a substance having a photocatalytic activity.

Examples of the alkoxysilanes having an alkyl group of 1 to 12 carbon atoms include methyltrimethoxysilane, dimethyldimethoxysilane, methyltriethoxysilane, dimethyldiethoxysilane, hexyltrimethoxysilane, hexyltriethoxysilane, decyltrimethoxysilane, decyltriethoxysilane and the like. Examples of the alkoxysilanes having an aryl group include phenyltrimethoxysilane, diphenyldimethoxysilane, phenyltriethoxysilane, diphenyldiethoxysilane and the like.

There may be suitably used, as the alkoxysilane having an epoxy group, γ-glycidoxypropyltrimethoxysilane, γ-glycidoxypropyltriethoxysilane, γ-glycidoxypropyltripropoxysilane, γ-glycidoxypropyltributoxysilane, 3,4-epoxycyclohexylmethyltrimethoxysilane, 3,4-epoxycyclohexylmethyltriethoxysilane, β-(3,4-epoxycyclohexyl)ethyltrimethoxysilane, β-(3,4-epoxycyclohexyl)ethyltriethoxysilane or the like, and γ-glycidoxypropyltriethoxysilane is used particularly suitably from the viewpoint of ease of handling, reactivity and the like.

There may be suitably used, as the alkoxysilane having an amino group, aminopropyltrimethoxysilane, aminopropyltriethoxysilane, (β-aminoethyl)-β-aminopropyltrimethoxysilane, (β-aminoethyl)-β-aminopropylmethyldimethoxysilane, (β-aminoethyl)-γ-aminopropyltrimethoxysilane or the like, and aminopropyltriethoxysilane is used particularly suitably from the viewpoint of ease of handling and the like.

Examples of the tetraalkoxysilanes include tetramethoxysilane, tetraethoxysilane, tetrapropoxysilane, tetrabutoxysilane and the like.

The treating solution contains an inorganic-organic composite resin material containing an alkoxysilane (a1) selected from the group consisting of the aforementioned silane compounds and combinations thereof, a hydrolyzate (a2) of the alkoxysilane (a1) and/or a condensate (a3) of the alkoxysilane (a1), and a substance having a photocatalytic activity.

A merit of inclusion of an alkoxysilane having an epoxy group or an alkoxysilane having an amino group in a treating solution is that adhesion with a substrate layer and stability to a photocatalyst are improved. Although the reason for this is not clear, it is believed that a strong bond contributing to adhesion with the substrate layer is formed by adding an epoxy group or an amino group.

The treating solution of the present invention contains a substance having a photocatalytic activity. It is possible to use, as the substance having a photocatalytic activity used in the present invention, photocatalyst particles, a sol-like material which cannot be regarded as a particles, and a material like a metal complex. Herein, the sol-like material refers to a precipitate produced by hydrolysis of a metal alkoxide in the treating solution, or a very fine colloid dispersed and stabilized in water or an organic solvent. As the photocatalyst of the present invention, anatase type titanium oxide particles, among others, can be used particularly suitably. There is also no particular limitation on properties of photocatalyst particles. However, it is preferred to use particles having a particle diameter as small as possible so as to provide a high catalytic activity. The size of photocatalyst particles is preferably 0.5 μm or less, more preferably 0.1 μm or less, and still more preferably 0.05 μm or less, in terms of a primary particle diameter. There is no particular limitation on the lower limit of the particle size. However, since it becomes difficult to handle when the particle size is too small, those having a primary particle diameter of 5 nm or more are usually used.

There is no particular limitation on the amount of the photocatalyst contained in the treating solution, and the amount can be appropriately determined as long as a desired effect can be obtained when a film is formed. In this case, except for a treating solution for forming an innermost layer film, the amount is usually adjusted to 50% by mass or less, preferably 40% by mass or less, and more preferably 30% or less, based on the total mass of non-volatile components in the treating solution so as not to impair uniformity, smoothness and the like when a film is formed. There is also no particular limitation on the lower limit of the additive amount, and the amount is usually 0.05% by mass or more, preferably 0.1% by mass or more, more preferably 0.5% by mass or more, and most preferably 1.0% by mass or more, based on the total mass of solid components contained in the treating solution.

In the case of the treating solution for forming the innermost layer film, the amount may be adjusted to 30% by mass or less, preferably 20% by mass or less, and more preferably 15% by mass or less, based on the total mass of non-volatile components in the treating solution. There is also no particular limitation on the lower limit of the additive amount, and the amount is usually 0.05% by mass or more based on the total mass of solid components contained in the treating solution. When the additive amount is too large exceeding the aforementioned range, there is no disadvantage in the treating solution. However, it becomes difficult to form a uniform and smooth film and also the catalyst is added in the amount more than the necessary amount, and therefore it is not economical. When the additive amount is too small outside the aforementioned range, the desired effect may often not be obtained.

In the treating solution of the present invention, an alkoxide of a metal component, other than tetraalkoxysilane, can also be used as an additive, as needed. In particular, when at least one alkoxide of metal selected from Ti, Al, Ta and Nb is added and acetic acid is used as the catalyst, a ring-opening rate of an epoxy group increases, resulting in a particularly large effect of curing at a low temperature within a short time. In the metal alkoxide other than the alkoxysilane, all or a portion of alkoxy groups may be hydrolyzed.

The treating solution of the present invention can contain, as needed, a compound of zirconium, for example, at least one of a zirconium alkoxide, a hydrolyzate thereof, or a zirconium oxide (zirconia) sol. This component is a component for improving alkali chemical resistance of a treating solution containing silica as a main component, which is used as the coating solution of the present invention. Although it is not necessarily made clear by what a mechanism alkali resistance is improved through the addition of this component, it is considered that Zr is substituted on a site of Si constituting a siloxane bond to form a network composed mainly of silica and zirconium, and thus it is stabilized against an alkali. If necessary, inorganic fine particles other than a zirconia sol can be added.

It is possible to add a color pigment, an extender pigment, a catalyst, a rust preventive pigment, a metal powder, a high frequency loss agent, an aggregate and the like to the treating solution of the present invention for the purpose of improving design properties, corrosion resistance, abrasion resistance, catalytic action and the like of a paint film.

Examples of the color pigments include oxides and composite oxides of Ti, Al and the like, and metal powders such as a Zn powder and an Al powder. It is preferred to use, as the rust preventive pigment, nonchromic acid pigments such as phosphates, calcium salts and aluminum salts, including calcium molybdate, calcium phosphomolybdate and aluminum phosphomolybdate, which are free from an environmental pollutant. Examples of the high frequency loss agents include Zn—Ni ferrite, and examples of the aggregates include a potassium titanate fiber and the like.

If necessary, an acid catalyst can be added to the treating solution of the present invention. Examples of the acid catalysts include organic acids such as formic acid, maleic acid, benzoic acid; and inorganic acids such as hydrochloric acid, nitric acid, and acetic acid is used particularly suitably. Use of an acid as the catalyst enables an alkoxysilane used as a raw material to become a polymerization state suited for film formation. In addition, use of acetic acid as the catalyst enables promotion of ring-opening of an epoxy group, resulting in a large effect of curing at a low temperature within a short time.

To the treating solution of the present invention, a levelling effect agent, an antioxidant, an ultraviolet absorber, a stabilizer, a plasticizer, a wax, an addition type ultraviolet stabilizer or the like can be mixed as an additive. As long as heat resistance or the like of a film is not impaired or deteriorated due to a photocatalyst does not arise, the solution may contain a resin-based coating material such as a fluororesin, a polyester resin, or a urethane resin.

These additives may be used alone, or a mixture of two or more additives can also be appropriately used.

The treating solution of the present invention can be prepared by adding an alkoxysilane (a1), which is selected from the group consisting of alkoxysilanes having an organic group selected from the group consisting of alkyl groups having 1 to 12 carbon atoms, aryl groups, carboxyl group, hydroxyl group and combinations thereof, alkoxysilanes having an epoxy group, alkoxysilanes having an amino group, tetraalkoxysilanes and combinations thereof in an organic solvent capable of suitably dispersing and dissolving a solute therein, and optionally allowing the alkoxysilane to undergo hydrolysis and condensation polymerization. As the organic solvent, it is preferred to use, for example, an alcohol such as methanol, ethanol, propanol or butanol, acetone, an aromatic organic solvent such as benzene, toluene, xylene or ethylbenzene, or a mixture thereof.

A substance having a photocatalytic activity is added to this treating solution to prepare a surface-treating solution.

The surface-treating solution thus prepared can be used after diluting with an organic solvent or water so as to meet a required film thickness. Commonly, the solution is diluted so that a film obtained by single coating has a thickness within a range from 0.2 to 5 μm. It is also possible to form a paint film having a larger thickness by plural coating operations. It is also possible to apply the solution after distilling off an alcohol or the like used as a solvent or produced by hydrolysis under a normal or reduced pressure.

The film on a surface of the surface-treated precoated metal sheet of the present invention can be formed by application of the aforementioned surface-treating solution on a surface of a precoated metal sheet which serves as a base material, followed by drying and curing. Application is carried out by a dip coating method, a spray coating method, a bar coating method, a roll coating method, a spin coating method or the like.

The paint film formed by the treating solution of the present invention is usually cured by heating. It is preferred to carry out a heat treatment under standard heating conditions at a temperature within a range of 150° C. to about 400° C. for about 1 hour to about several seconds. Commonly, when a heat treatment temperature is high, the film can be cured within a short heat treatment time. When a heat treatment temperature is low, a treatment for a long time is required. When it is impossible to carry out a drying or heat treatment at a sufficient temperature for a sufficient time, the film can be left to stand at room temperature for 1 to 5 days, as needed, after once subjected to drying, baking and curing. Through this step, it is possible to anticipate the effect of increasing hardness of a paint film when compared with the hardness immediately after formation of the paint film. This film can also be cured by being left to stand at room temperature after application. In this case, a long time may often be required until the film attains a practical hardness.

The two- or multi-layered film the respective layers of which have amounts of photocatalyst different from each other is obtained by repeated application of surface-treating solutions each having a content of photocatalyst different from that in other solutions, followed by curing. Alternatively, surface-treating solutions (A) and (B), which respectively have contents of photocatalyst different from each other, can be simultaneously applied on a surface of a metal sheet or a coated metal sheet, and then simultaneously dried and baked, to thereby form a multi-layered film in which two layers, which respectively have contents of particles having a photocatalytic activity, different from each other, are laminated on the surface of the metal sheet or coated metal sheet. Similarly, when a multi-layered film of three or more layers, including a layer of organic resin, is formed, it is possible to form a three-layered film including an organic resin-based paint layer by simultaneously applying a coating material (C) containing the organic resin and surface-treating solutions (A) and (B), and baking them. In this case, a method using a multi-layer curtain coater or the like is suitably used.

### EXAMPLES

The present invention will be specifically described by way of the following examples.

### Examples 1 to 9, Comparative Examples 1 and 2

After sufficiently stirring γ-glycidoxypropyltriethoxysilane (GPTES), phenyltriethoxysilane (PhTES), tetraethoxysilane (TEOS) and titanium tetraethoxide (TE) mixed in accordance with the formulation shown in Table 1, the resultant mixture was hydrolyzed using distilled water diluted with ethanol under an acetic acid-acidic condition. After adding aminopropyltriethoxysilane (APTES) thereto, the mixture was further hydrolyzed using a distilled water/ethanol mixed solution to prepare a coating solution containing an inorganic-organic composite resin as a main component. In the hydrolysis, a sufficient amount of water was added and the coating solution was adjusted so that it has a solid concentration of 10% by mass when dried at 150° C. To this coating solution, photocatalyst particles shown in Table 1 were added to prepare a surface-treating solution for coating. The amount of photocatalyst of an inner film was adjusted to ½ of the amount of photocatalyst of an outer film. The amount of photocatalyst added is percent by mass based on the total solid contained in the surface-treating solution. The particle diameters of photocatalyst particles used are about 60 nm for ZnO, and about 10 nm for TiO₂.

Surface-treated precoated metal sheets of Examples 1 to 9 were produced by using, as a base material, a precoated steel sheet obtained by coating a melamine-crosslinked polyester film having a thickness of about 15 μm on a surface of a 0.6 mm thick zinc-plated steel sheet. A film as the first layer (inner layer) of a surface-treated film (photocatalyst film) having a two-layered structure was formed by applying the aforementioned surface-treating solution for the outer layer to a precoated steel sheet as a base material using a bar coater, and subjecting it to a heat treatment at a maximum temperature of 210° C. using a temperature rising condition under which a sheet temperature becomes 250° C. after 50 seconds. The film thus formed had a thickness of about 3 μm. Further, a film as the second layer (outer layer) was formed by applying the aforementioned surface-treating solution for the inner layer on the surface having the film as the first layer formed using a bar coater, and subjecting it to a heat treatment at a maximum temperature of 250° C. using a temperature rising condition under which a sheet temperature becomes 250° C. after 50 seconds. The film thus formed had a thickness of about 3 μm. As comparative materials, a surface-treated precoated metal sheet (Comparative Example 1) having a film (thickness: about 2 μm) only with the second layer (outer layer) formed by the very same method as that mentioned above, and a surface-treated precoated metal sheet (Comparative Example 2) having a melamine-crosslinked polyester layer (thickness: 15 μm) containing TiO₂ particles dispersed therein as the outermost layer.

Evaluation tests of the surface-treated precoated metal sheets were carried out by the following methods:

(1) An outdoor exposure test was carried out and raindrop fouling resistance was evaluated. Specimens were disposed in the direction perpendicular to the ground while surfaces with a photocatalyst film formed faces the south.
(2) The state of deterioration (damage) of the paint film was examined by measuring color and luster of the surface of the exposed specimen every about 1 month. Since a photocatalyst film is whitish and transparent, the measurement results of color and luster greatly reflect the state of the polyester film as the lower layer.
(3) The surface of the aforementioned exposed specimen was slightly rubbed with fingers and the state of chalking was judged.
(4) After a lapse of 6 months and after a lapse of 1 year, a cross section of the film was observed and an approximate persistence period of self-cleaning function was estimated by measuring a decrease in film thickness.

The test results were evaluated by four-rank criteria (A, B, C and D in the order from the high level), except for the decrease in film thickness and the persistence period of self-cleaning function. The respective evaluation criteria are shown in Table 2.

The results are also shown in Table 1. In both Examples and Comparative Examples, all surface-treated precoated metal sheets with a photocatalyst film formed had excellent fouling resistance. In the Examples, the film is reduced in deterioration and shows comparatively satisfactory chalking properties. Because of the two-layered film, although the film thickness moderately decreases, the persistence periods of self-cleaning properties are longer than that of Comparative Example 1 of the film of one layer. Bending workability was examined by carrying out a 2T bending test, although not shown in the table. As a result, neither cracking nor peeling of the film was recognized, even for the comparative materials, and the films had excellent bending workability.

On the other hand, in Comparative Example 1 having a photocatalyst film made of only one layer, the state of deterioration of the film judged by comprehensively taking self-cleaning (raindrop fouling resistance) properties and chalking properties into consideration is identical to that of the photocatalyst films of the Examples. However, the persistence period of self-cleaning properties is short since the film is made of only one layer. In Comparative Example 2, although satisfactory self-cleaning properties are obtained by the photocatalytic effect, severe chalking and deterioration of the film arose and the overall evaluation was rated “D”.

Summarizing the above, it is apparent that the surface-treated precoated metal sheets of the Examples can maintain satisfactory fouling resistance and self-cleaning properties over a long period.

### Examples 10 to 18

To the coating solution with the composition shown in Example 3 of Table 1 (containing no photocatalyst particles added therein), photocatalyst particles were added in the amount shown in Table 3 to prepare three surface-treating solutions for the respective Examples. Photocatalyst particles used are ZnO particles and anatase type TiO₂, both of which are the same as those in Example 1.

A precoated metal sheet as a base material was produced by coating a melamine-crosslinked polyester film having a thickness of about 15 μm on the outermost surface of a 0.6 mm thick zinc-plated steel sheet which was the same as that used in Examples 1 to 9. First, a surface-treating solution C was applied on the painted surface of the precoated metal sheet as a base material using a bar coater and then heated at 210° C. to form a third layer (innermost layer). Subsequently, on this surface, a surface-treating solution B was applied using a bar coater and then heated at 210° C. to form a second layer. Furthermore, on this surface, a surface-treating solution A was applied using a bar coater and then heated at 250° C. to form a first layer (outermost layer). As a result, a surface-treated precoated metal sheet was obtained in which a photocatalyst film of three layers, which respectively have contents of photocatalyst different from each other, is formed on a surface of the precoated metal sheet as a base material. The first layer had a thickness of 4 μm, and the second and third layers had a thickness of 3 μm.

Performance evaluation tests of the surface-treated precoated metal sheets were carried out, with respect to raindrop fouling resistance and deterioration of the film, in the same manner as in Examples 1 to 9. In the exposure test, since it takes time for the second layer or the innermost layer to become exposed, the specimens made in advance so that they have the second layer or the third layer at the outermost surface, that is, the specimens coated only with the innermost layer and the specimens coated with the innermost layer and the second layer were made when the aforementioned surface-treating metals were made, and the test was carried out using these specimens. In this case, a baking temperature of the film at the outermost surface was 250° C.

The results are also shown in Table 3. As is apparent from the results shown in Table 3, all of the outermost layer, the second layer and the innermost layer of the photocatalyst films formed on the surface-treated precoated metal sheets of the Examples are excellent in fouling resistance, and they can maintain satisfactory fouling resistance over a long period because of a three-layered structure. Also, since deterioration of the film due to the photocatalyst is reduced and all three layers have photocatalyst resistance, excellent fouling resistance with less film deterioration can be maintained over a long period. Bending workability was examined by carrying out a 2T bending test. As a result, neither cracking nor peeling of the film was recognized and bending workability thereof was excellent.

As described in these Examples, it is possible to form, on a surface of a precoated metal sheet, a film of a plurality of layers each containing an inorganic-organic composite with a specific composition as a matrix, and containing a predetermined amount of photocatalyst particles added. As a result, it has been found to be possible to obtain a surface-treated precoated metal sheet which maintains excellent fouling resistance over a long period and has reduced film deterioration.

### Examples 19 to 26

After sufficiently stirring γ-glycidoxypropyltriethoxysilane (GPTES), phenyltriethoxysilane (PhTES), methyltriethoxysilane (MTES), tetraethoxysilane (TEOS) and titanium tetraethoxide (TE) mixed in accordance with the formulation shown in Table 4, the resultant mixture was hydrolyzed using distilled water diluted with ethanol under an acetic acid-acidic condition. After adding aminopropyltriethoxysilane (APTES) thereto, the mixture was further hydrolyzed using a distilled water/ethanol mixed solution to prepare a treating solution containing an inorganic-organic composite as a main component. In the hydrolysis, a sufficient amount of water was added and the treating solution was adjusted so that it has a solid concentration of 15% by mass when dried at 150° C. To this treating solution, a photocatalyst in a sol state was added in the amount shown in Table 4 to prepare a final surface-treating solution for coating. The amount of photocatalyst added is the amount in terms of the solid component as the photocatalyst contained in the sol and is percent by mass based on the total solid contained in the surface-treating solution.

The surface-treating solution thus prepared was applied on a surface of a precoated stainless steel sheet obtained by forming a silicone-acrylic film on a 0.5 mm thick stainless steel sheet (SUS430) to produce a surface-treated precoated metal sheet. First, a surface-treating solution D was applied using a bar coater and then heated at 210° C. to form a fourth layer (innermost layer). Subsequently, on this surface, a surface-treating solution C and a surface-treating solution B were applied in this order in the same procedure and method as in case of application of the surface-treating solution D to form a third layer and a second layer. Further, on this surface, a surface-treating solution A was applied using a bar coater and then heated at 250° C. to form a first layer (outermost layer). As a result a surface-treated precoated metal sheet was obtained in which a photocatalyst film of four layers (three layers in Examples 19 to 22), which respectively have contents of photocatalyst different from each other, is formed on a surface of the substrate metal surface. In all of the Examples, the layers had a thickness of 4 μm.

Performance evaluation tests of the surface-treated precoated metal sheets were carried out, with respect to raindrop fouling resistance and deterioration of the film, in the same manner as in Examples 10 to 18. The results were evaluated by four-rank criteria (A, B, C and D) in the same manner as in Examples 1 to 9 and Examples 10 to 18. The respective evaluation criteria are as shown in Table 2.

The results are shown in Table 4. As is apparent from the results shown in Table 4, in the photocatalyst film formed on the surface-treated precoated metal sheet of each Example all of the layers from the outermost to the innermost are excellent in fouling resistance, and the film can maintain satisfactory fouling resistance over a long period since it has a three or four layer structure. Since deterioration of the film due to the photocatalytic effect is reduced and all layers have photocatalyst resistance, it is possible for the film to maintain excellent fouling resistance with less film deterioration over a long period. Bending workability was examined by carrying out a 2T bending test. As a result, neither cracking nor peeling of the film was recognized, and the film had excellent bending workability.

As described in these Examples, it is possible to form, on a surface of a precoated stainless steel sheet, a film of a plurality of layers each containing an inorganic-organic composite with a specific composition as a matrix, and containing a predetermined amount of photocatalyst particles added. As a result, it has been found that the surface-treated precoated stainless steel sheets thus obtained are materials which maintain excellent fouling resistance over a long period and have reduced deterioration of the surface film.

### Examples 27 and 28

On a surface of a precoated steel sheet as a base material in which a melamine-crosslinked polyester film having a thickness of about 15 μm is coated on an outermost surface of a 0.6 mm thick zinc-plated steel sheet, a surface-treating solution (amount of photocatalyst particles added: 5.0% by mass) (see Table 5) prepared according to the formulation described in Example 1 of Table 1 was applied to form an inner photocatalyst layer, and then a surface-treating solution (amount of photocatalyst particles added: 20.0% by mass) (see Table 5) prepared according to the formulation described in Example 4 of Table 1 was applied thereon to form an outer layer, thus producing a precoated metal sheet including a photocatalyst film composed of two layers (Example 27). On a surface of the same precoated steel sheet, a surface-treating solution (amount of photocatalyst particles added: 5.0% by mass) (see Table 5) prepared according to the formulation described in Example 2 of Table 1 was applied to form an inner photocatalyst layer and then a surface-treating solution (amount of photocatalyst particles added: 25.0% by mass) (see Table 5) prepared according to the formulation described in Example 8 was applied to form an outer photocatalyst layer, thus producing a precoated metal sheet including a two-layered photocatalyst film (Example 28).

The photocatalyst film was formed by simultaneous application of a treating solution for an inner layer and a treating solution for an outer layer using a slit curtain coater, followed by curing with heating at 250° C. The surface-treated precoated metal sheet thus prepared showed satisfactory appearance without any problem. In the film thus formed, the inner layer had a thickness of about 4 μm and the outer layer had a thickness of about 6 μm.

With respect to the surface-treated precoated metal sheet prepared, raindrop fouling resistance, the state of deterioration (damage) of the film and the state of chalking were evaluated by an outdoor exposure test in the same manner as in Examples 1 to 9. Also, an approximate persistence period of the self-cleaning function was estimated. The results are shown in Table 5.

As a result, with respect to raindrop fouling resistance, the state of deterioration of the film and the state of chalking, Example 27 showed the very same test results as in Example 4, and Example 28 showed the very same test results as in Example 8. Also, the estimated persistence periods of the self-cleaning function were about 30 years for the surface-treated precoated steel sheet of Example 27, and about 16 years for the surface-treated precoated steel sheet of Example 28.

As described in these Examples, it has been found that the surface-treated precoated metal sheet of the present invention can also be produced without any problem by a simultaneous multilayer coating method. It has also been found that the performance of the product is the very same as in the case where the respective layers of film are independently formed. It has been found that, also in the surface-treated precoated metal sheets produced by the method described in these Examples, satisfactory fouling resistance can be obtained and self-cleaning properties can be maintained over a long period, and film deterioration due to the photocatalyst is reduced.

TABLE 1

| | | | | | | | Amount of |
|---|---|---|---|---|---|---|---|
| | | | | | | | photocatalyst |
| | GPTES | PhTES | TEOS | TE | APTES | | particles |
| | (Parts | (Parts | (Parts | (Parts | (Parts | | added |
| | by | by | by | by | by | Photocatalyst | (Parts by |
| No. | mass) | mass) | mass) | mass) | mass) | particles | mass) |
| Example 1 | 0 | 144.0 | 87.0 | 0 | 0 | ZnO | 10.0 (Outer) |
| | | | | | | | 5.0 (Inner) |
| Example 2 | 0 | 144.0 | 87.0 | 0 | 0 | Anatase type | 10.0 (Outer) |
| | | | | | | TiO₂ | 5.0 (Inner) |
| Example 3 | 100 | 144.0 | 87.0 | 8.2 | 39.7 | ZnO | 10.0 (Outer) |
| | | | | | | | 5.0 (Inner) |
| Example 4 | 100 | 144.0 | 87.0 | 8.2 | 39.7 | ZnO | 20.0 (Outer) |
| | | | | | | | 10.0 (Inner) |
| Example 5 | 100 | 144.0 | 87.0 | 8.2 | 39.7 | ZnO | 40.0 (Outer) |
| | | | | | | | 20.0 (Inner) |
| Example 6 | 100 | 144.0 | 87.0 | 8.2 | 39.7 | Anatase type | 1.0 (Outer) |
| | | | | | | TiO₂ | 0.5 (Inner) |
| Example 7 | 100 | 144.0 | 87.0 | 8.2 | 39.7 | Anatase type | 5.0 (Outer) |
| | | | | | | TiO₂ | 2.5 (Inner) |
| Example 8 | 100 | 144.0 | 87.0 | 8.2 | 39.7 | Anatase type | 25.0 (Outer) |
| | | | | | | TiO₂ | 12.5 (Inner) |
| Example 9 | 100 | 144.0 | 87.0 | 8.2 | 39.7 | Anatase type | 50.0 (Outer) |
| | | | | | | TiO₂ | 25.0 (Inner) |
| Comparative | 100 | 144.0 | 87.0 | 8.2 | 39.7 | Anatase type | 25.0 |
| Example 1 | | | | | | TiO₂ | |

| | | | |
|---|---|---|---|
| Comparative | Comparative material (melamine- | Anatase type | 25.0 |
| Example 2 | crosslinked polyester) | TiO₂ | |

| | | | | Decrease in | | | |
|---|---|---|---|---|---|---|---|
| | | | | film thickness | | Persistence | |
| | Raindrop | | | (μm) | | period of | |
| | fouling | Deterioration | | After 6 | After 1 | self-cleaning | Overall |
| No | resistance | of film | Chalking | months | year | properties | evaluation |
| Example 1 | B | A | A | 0.3 | 0.5 | About 24 | B |
| | | | | | | years | |
| Example 2 | A | A | A | 0.3 | 0.7 | About 13 | A |
| | | | | | | years | |
| Example 3 | A | A | A | 0.2 | 0.5 | About 20 | A |
| | | | | | | years | |
| Example 4 | A | A | A | 0.4 | 0.7 | About 11 | A |
| | | | | | | years | |
| Example 5 | A | B | B | 0.6 | 1.2 | About 6 years | B |
| Example 6 | A | A | A | 0.1 | 0.3 | About 32 | A |
| | | | | | | years | |
| Example 7 | A | A | A | 0.2 | 0.5 | About 20 | A |
| | | | | | | years | |
| Example 8 | A | A | B | 0.5 | 1.1 | About 9 years | A |
| Example 9 | A | B | B | 0.7 | 1.5 | About 5 years | B |
| Comparative | A | A | B | 0.6 | 1.2 | About 2 years | C |
| Example 1 | | | | | | | |
| Comparative | A | D | D | 2.5 | 6.0 | Unpredictable | D |
| Example 2 | | | | | | | |

TABLE 2

| | Raindrop fouling | Deterioration of | Chalking |
|---|---|---|---|
| Criteria | and dust fouling | paint film | properties |
| A | Inconspicuous | No deterioration | No migration even |
| | fouling after | arises after | when rubbed with |
| | exposure for 6 | exposure for 6 | fingers |
| | months | months (Luster | |
| | | retention of 90% | |
| | | or more) | |
| B | Slight fouling | Slightly | Slight migration |
| | after exposure | deteriorated | when rubbed with |
| | for 6 months | after exposure | fingers |
| | | for 6 months | |
| | | (Luster retention | |
| | | of 60% to less | |
| | | than 90%) | |
| C | Fouling after | Deterioration is | Observable |
| | exposure for 6 | observed after | migration when |
| | months | exposure for 6 | rubbed with |
| | | months (Luster | fingers |
| | | retention of less | |
| | | than 60%) | |
| D | Observable | Deterioration is | Remarkable |
| | fouling after | observed after | migration when |
| | exposure for 3 | exposure for 3 | rubbed with |
| | months | months (Luster | fingers |
| | | retention of less | |
| | | than 50%) | |

TABLE 3

| | | Surface-treating | | Surface-treating | | Surface-treating | |
|---|---|---|---|---|---|---|---|
| | | solution A | | solution B | | solution C | |
| | | (Outermost surface) | | (Middle layer) | | (Base material side) | |
| | Composition | | Content | | Content | | Content |
| | of treating | | (% by | | (% by | | (% by |
| No | solution | Photocatalyst | mass) | Photocatalyst | mass) | Photocatalyst | mass) |
| Example | The same as | ZnO | 10.0 | ZnO | 5.0 | ZnO | 1.0 |
| 10 | Example 3 | | | | | | |
| Example | The same as | ZnO | 25.0 | ZnO | 20.0 | ZnO | 5.0 |
| 11 | Example 3 | | | | | | |
| Example | The same as | ZnO | 40.0 | ZnO | 10.0 | ZnO | 2.5 |
| 12 | Example 3 | | | | | | |
| Example | The same as | TiO₂ | 20.0 | TiO₂ | 15.0 | TiO₂ | 5.0 |
| 13 | Example 3 | | | | | | |
| Example | The same as | TiO₂ | 30.0 | TiO₂ | 10.0 | TiO₂ | 1.0 |
| 14 | Example 3 | | | | | | |
| Example | The same as | TiO₂ | 50.0 | TiO₂ | 35.0 | TiO₂ | 25.0 |
| 15 | Example 3 | | | | | | |
| Example | The same as | ZnO | 30.0 | TiO₂ | 15.0 | TiO₂ | 5.0 |
| 16 | Example 3 | | | | | | |
| Example | The same as | TiO₂ | 10.0 | ZnO | 7.5 | TiO₂ | 2.0 |
| 17 | Example 3 | | | | | | |
| Example | The same as | TiO₂ | 25.0 | TiO₂ | 10.0 | ZnO | 1.0 |
| 18 | Example 3 | | | | | | |

| | First layer | | Second layer | | Third layer | | |
|---|---|---|---|---|---|---|---|
| | (Outermost layer) | | (Second layer) | | (Innermost layer) | | |
| | Raindrop | | Raindrop | | Raindrop | | |
| | fouling | Deterioration | fouling | Deterioration | fouling | Deterioration | Overall |
| No. | resistance | of film | resistance | of film | resistance | of film | evaluation |
| Example | A | A | A | A | B | A | A |
| 10 | | | | | | | |
| Example | A | A | A | A | A | A | A |
| 11 | | | | | | | |
| Example | A | B | A | A | A | A | A |
| 12 | | | | | | | |
| Example | A | A | A | A | A | A | A |
| 13 | | | | | | | |
| Example | A | A | A | A | B | A | A |
| 14 | | | | | | | |
| Example | A | B | A | B | A | B | B |
| 15 | | | | | | | |
| Example | A | A | A | A | A | A | A |
| 16 | | | | | | | |
| Example | A | A | A | A | A | A | A |
| 17 | | | | | | | |
| Example | A | A | A | A | B | A | A |
| 18 | | | | | | | |

TABLE 4

| | GPTES | PhTES | MTES | TEOS | TE | APTES |
|---|---|---|---|---|---|---|
| | (Parts | (Parts | (Parts | (Parts | (Parts | (Parts |
| No. | by mass) | by mass) | by mass) | by mass) | by mass) | by mass) |
| Example 19 | 100 | 0 | 106.8 | 87.0 | 8.2 | 39.7 |
| Example 20 | 100 | 0 | 106.8 | 87.0 | 8.2 | 39.7 |
| Example 21 | 100 | 0 | 106.8 | 87.0 | 8.2 | 39.7 |
| Example 22 | 100 | 0 | 106.8 | 87.0 | 8.2 | 39.7 |
| Example 23 | 100 | 72.0 | 53.4 | 87.0 | 8.2 | 39.7 |
| Example 24 | 100 | 72.0 | 53.4 | 87.0 | 8.2 | 39.7 |
| Example 25 | 100 | 72.0 | 53.4 | 87.0 | 8.2 | 39.7 |
| Example 26 | 100 | 72.0 | 53.4 | 87.0 | 8.2 | 39.7 |

| | Surface-treating | | Surface-treating | | Surface-treating | | Surface-treating | |
|---|---|---|---|---|---|---|---|---|
| | solution A | | solution B | | solution C | | solution D | |
| | (Outermost layer) | | (Second layer) | | (Third layer) | | (Innermost layer) | |
| | | Content | | Content | | Content | | Content |
| | | (% by | | (% by | | (% by | | (% by |
| No. | Photocatalyst | mass) | Photocatalyst | mass) | Photocatalyst | mass) | Photocatalyst | mass) |
| Example | TiO₂ | 20.0 | TiO₂ | 5.0 | None | | TiO₂ | 1.0 |
| 19 | | | | | | | | |
| Example | TiO₂ | 30.0 | TiO₂ | 10.0 | None | | TiO₂ | 5.0 |
| 20 | | | | | | | | |
| Example | ZnO | 10.0 | ZnO | 3.0 | None | | ZnO | 0.5 |
| 21 | | | | | | | | |
| Example | ZnO | 30.0 | ZnO | 20.0 | None | | ZnO | 10.0 |
| 22 | | | | | | | | |
| Example | TiO₂ | 10.0 | TiO₂ | 5.0 | TiO₂ | 2.5 | TiO₂ | 0.5 |
| 23 | | | | | | | | |
| Example | TiO₂ | 25.0 | TiO₂ | 20.0 | TiO₂ | 7.5 | TiO₂ | 2.5 |
| 24 | | | | | | | | |
| Example | ZnO | 20.0 | ZnO | 10.0 | ZnO | 5.0 | ZnO | 2.0 |
| 25 | | | | | | | | |
| Example | ZnO | 30.0 | ZnO | 15.0 | ZnO | 10.0 | ZnO | 2.5 |
| 26 | | | | | | | | |

| | First layer | | Second layer | | Third layer | | Forth layer | | |
|---|---|---|---|---|---|---|---|---|---|
| | (Outermost layer) | | (Second layer) | | (Third layer) | | (Innermost layer) | | |
| | Raindrop | | Raindrop | | Raindrop | | Raindrop | | |
| | fouling | Deterioration | fouling | Deterioration | fouling | Deterioration | fouling | Deterioration | Overall |
| No | resistance | of film | resistance | of film | resistance | of film | resistance | of film | evaluation |
| Example 19 | A | A | A | A | None | | A | A | A |
| Example 20 | A | A | A | A | None | | A | A | A |
| Example 21 | A | A | A | A | None | | B | A | A |
| Example 22 | A | A | A | A | None | | A | A | A |
| Example 23 | A | A | A | A | A | A | B | A | A |
| Example 24 | A | A | A | A | A | A | A | A | A |
| Example 25 | A | A | A | A | A | A | A | A | A |
| Example 26 | A | A | A | A | A | A | A | A | A |

TABLE 5

| | | | | | | | Amount of |
|---|---|---|---|---|---|---|---|
| | | | | | | | Photocatalyst |
| | GPTES | PhTES | TEOS | TE | APTES | | particles |
| | (Parts | (Parts | (Parts | (Parts | (Parts | | added |
| | by | by | by | by | by | Photocatalyst | (Parts by |
| No. | mass) | mass) | mass) | mass) | mass) | particles | mass) |
| Example 27 | 0 | 144.0 | 87.0 | 0 | 0 | ZnO | 5.0 |
| (Inner | | | | | | | |
| layer) | | | | | | | |
| Example 27 | 100 | 144.0 | 87.0 | 8.2 | 39.7 | ZnO | 20.0 |
| (Outer | | | | | | | |
| layer) | | | | | | | |
| Example 28 | 0 | 144.0 | 87.0 | 0 | 0 | Anatase type | 5.0 |
| (Inner | | | | | | TiO₂ | |
| layer) | | | | | | | |
| Example 28 | 100 | 144.0 | 87.0 | 8.2 | 39.7 | Anatase type | 25.0 |
| (Outer | | | | | | TiO₂ | |
| layer) | | | | | | | |

| | | | | Decrease in | | Persistence | |
|---|---|---|---|---|---|---|---|
| | | | | film thickness | | period of | |
| | Raindrop | | | (μm) | | self- | |
| | fouling | Deterioration | | After 6 | After 1 | cleaning | Overall |
| No | resistance | of film | Chalking | months | year | properties | evaluation |
| Example | A | A | A | 0.3 | 0.6 | About 30 | A |
| 27 | | | | | | years | |
| Example | A | A | B | 0.5 | 1.1 | About 16 | A |
| 28 | | | | | | years | |

1. A surface-treated precoated metal sheet having at least a two-layered film having a photocatalytic activity formed on a precoated metal sheet, the precoated metal sheet having a substrate metal sheet and an organic resin coating layer on a surface thereof, wherein the at least two-layered film contains an inorganic-organic composite resin composed of a condensate of an alkoxysilane, which is selected from the group consisting of alkoxysilanes having an organic group selected from the group consisting of alkyl groups having 1 to 12 carbon atoms, aryl groups, carboxyl group, hydroxyl group and combinations thereof, alkoxysilanes having an epoxy group, alkoxysilanes having an amino group, tetraalkoxysilanes and combinations thereof, and also contains a substance having a photocatalytic activity so that the content thereof is the largest in an outermost layer and gradually decreases toward an inner layer.

2. The surface-treated precoated metal sheet according to claim 1, wherein the organic group contained in the inorganic-organic composite resin is a methyl group or a phenyl group.

3. The surface-treated precoated metal sheet according to claim 1, wherein the content of substance having a photocatalytic activity in each layer of the film is from 0.05% to 50% of the total mass of the layer.

4. The surface-treated precoated metal sheet according to claim 1, wherein the content of photocatalyst substance in an innermost layer in contact with the organic resin coating layer is from 0.05% to 30% by mass based on the total mass of the innermost layer.

5. The surface-treated precoated metal sheet according to claim 1, wherein the substance having a photocatalytic activity is titanium oxide including an anatase type structure.

6. The surface-treated precoated metal sheet according to claim 1, wherein the substrate metal sheet is selected from steel sheets, stainless steel sheets, titanium sheets, titanium alloy sheets, aluminum sheets, aluminum alloy sheets, or plated metal sheets obtained by subjecting said metal sheets to a plating treatment.

7. A surface-treating solution comprising an inorganic-organic composite resin material containing an alkoxysilane (a1), which is selected from the group consisting of alkoxysilanes having an organic group selected from the group consisting of alkyl groups having 1 to 12 carbon atoms, aryl groups, carboxyl group, hydroxyl group and combinations thereof, alkoxysilanes having an epoxy group, alkoxysilanes having an amino group, tetraalkoxysilanes and combinations thereof, a hydrolyzate (a2) of the alkoxysilane (a1) and/or a condensate (a3) of the alkoxysilane (a1); and a substance having a photocatalytic activity.

8. A method for producing a surface-treated precoated metal sheet, which comprises applying the surface-treating solution according to claim 7 to a precoated metal sheet including an organic resin coating layer, and curing the surface-treating solution.

9. A method for producing a surface-treated precoated metal sheet, which comprises simultaneously applying a plurality of the surface-treating solutions according to claim 7, the contents of the substance having a photocatalytic activity being different from solution to solution, on a precoated metal sheet having an organic resin coating layer; and then simultaneously drying and baking the surface-treating solutions to form, on the organic resin coating layer, a multi-layered film so that the content of the substance having a photocatalytic activity is the largest in an outermost layer and gradually decreases toward an inner layer.
